(19) United States
(12) Patent Application Publication
(10) Pub. No.: US 2015/0101368 A1
(43) Pub. Date: Apr. 16, 2015

(54) OPTICAL FIBER COOLING APPARATUS AND OPTICAL FIBER MANUFACTURING METHOD

(71) Applicant: SUMITOMO ELECTRIC INDUSTRIES, LTD., Osaka (JP)

(72) Inventors: Norihiro UENOYAMA, Yokohama-shi (JP); Iwao OKAZAKI, Yokohama-shi (JP); Manabu SHIOZAKI, Yokohama-Shi (JP); Tadashi ENOMOTO, Yokohama-shi (JP)

(21) Appl. No.: 14/510,517

(22) Filed: Oct. 9, 2014

(30) Foreign Application Priority Data
Oct. 10, 2013 (JP) 2013-212776

(51) Int. Cl. C03B 37/02

(52) U.S. Cl. CPC C03B 37/02; C03B 2205/55
USPC 65/434; 65/513

(57) ABSTRACT

When a lower gauge pressure of a cooling tube part is set at A, and the number of divided units of the cooling tube part is set at N, and a length of each of the divided units of the cooling tube part is set at Li (i=1 to N), and a radius of each of the divided units of the cooling tube part is set at Ri (i=1 to N), and a gas flow rate of a coolant gas passed through each of the divided units of the cooling tube part is set at Qi (i=1 to N), and a viscosity coefficient of a coolant gas is set at μ1, and a radius of an optical fiber is set at r1, and a drawing speed of the optical fiber is set at V1, and a pressure loss of a straight tube part is set at B, and the number of divided units of the straight tube part is set at n, and a length of each of the divided units of the straight tube part is set at LLj (j=1 to n), and a radius of each of the divided units of the straight tube part is set at RRj (j=1 to n), and a gas flow rate of a pressurized gas passed through the straight tube part is set at Q_{gas}, and a viscosity coefficient of the pressurized gas is set at μ2, and a pressure loss of a pressurizing chamber is set at C, and internal pressure correlation constants of the pressurizing chamber are set at D1 to D5, and a shape correction coefficient of the pressurizing chamber is set at k (1≦k≦2), an optical fiber cooling apparatus satisfies the following formula.

A−B−kC≦0

where

$$[ Mathematical Formula 1 ]$$

$$A = {\sum }_{i = 1}^{N} ( \frac{- {Q}_{i} + π {V}_{1} ( \frac{{R}_{i}^{2} - {r}_{1}^{2}}{2 ln ( {r}_{1} / {R}_{i} )} + {r}_{1}^{2} )}{\frac{π}{8 {μ}_{1}} ( {r}_{1}^{2} - {R}_{i}^{2} ) ( {r}_{1}^{2} + {R}_{i}^{2} + \frac{{R}_{i}^{2} - {r}_{1}^{2}}{ln ( {r}_{1} / {R}_{i} )} )} ) \times {L}_{i} \\ [ Mathematical Formula 2 ]$$

$$B = {\sum }_{j = 1}^{n} - ( \frac{{Q}_{gas} + π {V}_{1} ( \frac{{RR}_{j}^{2} - {r}_{1}^{2}}{2 ln ( {r}_{1} / {RR}_{j} )} + {r}_{1}^{2} )}{\frac{π}{8 {μ}_{2}} ( {r}_{1}^{2} - {RR}_{j}^{2} ) ( {r}_{1}^{2} + {RR}_{j}^{2} + \frac{{RR}_{j}^{2} - {r}_{1}^{2}}{ln ( {r}_{1} / {RR}_{j} )} )} ) \times {LL}_{j} \\ [ Mathematical Formula 3 ]$$

$$C = D 1 + D 2 \times {Q}_{gas} + D 3 \times {Q}_{gas}^{2} + D 4 \times V 1 + D 5 \times {Q}_{gas} \times V 1$$

### CROSS-REFERENCE TO RELATED APPLICATION

The present application claims priorities from Japanese Patent Application No. 2013-212776 filed on Oct. 10, 2013, the entire content of which is incorporated herein by reference.

### BACKGROUND OF INVENTION

1. Field of Invention

The present invention relates to an optical fiber cooling apparatus for forcedly cooling an optical fiber drawn from an optical fiber glass preform, and an optical fiber manufacturing method using the cooling apparatus.

2. Related Art

An optical fiber is manufactured by heating and melting an optical fiber glass preform (hereinafter called a glass preform) with an optical fiber drawing furnace (hereinafter called a drawing furnace) and being drawn from the downward side of the drawing furnace. The optical fiber drawn from the glass preform is coated by, for example, applying and curing an ultraviolet curable resin, but the resin cannot be applied at once since the temperature of the optical fiber just after drawing is high. Because of this, an optical fiber cooling apparatus is formed between the drawing furnace and a resin applicator, and the optical fiber just after drawing is forcedly cooled.

For the optical fiber cooling apparatus described above, for example, Patent Reference 1 discloses a technique for guiding a coolant gas so that the coolant gas flows upwardly. As shown in FIG. 7, an optical fiber cooling apparatus 100 has a gas inlet chamber 104 communicating with a cooling path 102a in the lower end of a cooling tube 102 for cooling an optical fiber 101. This gas inlet chamber 104 has a gas inlet 104a, and a gas G2 such as a helium gas is introduced from this gas inlet 104a.

The gas G2 flowing into the cooling path 102a from the gas inlet chamber 104 through a communication path 104b presses a coolant gas G1 such as a helium gas of the inside of the cooling path 102a. Then, a pressure of the coolant gas G1 in the vicinity of the gas inlet chamber 104 increases and thereafter, fluid resistance received at the time when the coolant gas G1 introduced from the side of a gas inlet 103 flows increases to increase a pressure loss. In this manner, the pressure loss of an outgoing side region is increased and an upward flow of the coolant gas G1 is remarkably generated and cooling efficiency is increased.

The upward flow of the coolant gas G1 collides with an associated flow of the optical fiber 101 flowing in a direction of movement of the optical fiber 101 inside the cooling path 102a. Accordingly, the coolant gas G1 makes direct contact with a place exposed from the associated flow of the optical fiber 101, and the optical fiber 101 is cooled more effectively.

### PRIOR ART LITERATURE

### Patent Reference

[Patent Reference 1] Japanese Patent No. 4214389

However, in the above, a lower wall surface of the gas inlet chamber 104 is provided with an outgoing part 105 which is a through hole, and the optical fiber 101 is fed out of this outgoing part 105, but a helium gas may escape from a gap between the optical fiber 101 and a peripheral surface of the outgoing part 105. Since the helium gas is generally expensive, it is desirable to minimize leakage of the helium gas, but Patent Reference 1 does not concretely mention that leakage of the coolant gas from the lower side of the optical fiber cooling apparatus is prevented.

### SUMMARY OF INVENTION

Exemplary embodiments provide an optical fiber cooling apparatus capable of minimizing leakage of a coolant gas from the lower side of the apparatus, and an optical fiber manufacturing method using the cooling apparatus.

An optical fiber manufacturing method, according to the exemplary embodiment of the invention, uses an optical fiber cooling apparatus for forcedly cooling an optical fiber drawn from an optical fiber glass preform by a coolant gas, the optical fiber cooling apparatus having a cooling tube part in which a path of the coolant gas is formed, a pressurizing chamber formed in a lower portion of the cooling tube part, and a straight tube part formed in a lower portion of the pressurizing chamber,

wherein when a lower gauge pressure of the cooling tube part is set at A, and the number of divided units of the cooling tube part is set at N, and a length of each of the divided units of the cooling tube part is set at Li (i=1 to N), and a radius of each of the divided units of the cooling tube part is set at Ri (i=1 to N), and a gas flow rate of a coolant gas passed through each of the divided units of the cooling tube part is set at Qi (i=1 to N), and a viscosity coefficient of the coolant gas is set at μ1, and a radius of the optical fiber is set at r1, and a drawing speed of the optical fiber is set at V1, and a pressure loss of the straight tube part is set at B, and the number of divided units of the straight tube part is set at n, and a length of each of the divided units of the straight tube part is set at LLj (j=1 to n), and a radius of each of the divided units of the straight tube part is set at RRj (j=1 to n), and a gas flow rate of a pressurized gas passed through the straight tube part is set at Q_{gas}, and a viscosity coefficient of the pressurized gas is set at μ2, and a pressure loss of the pressurizing chamber is set at C, and internal pressure correlation constants of the pressurizing chamber are set at D1 to D5, and a shape correction coefficient of the pressurizing chamber is set at k the following formula is satisfied.

A−B−kC≦0

where

$$[ Mathematical Formula 1 ]$$

$$A = {\sum }_{i = 1}^{N} ( \frac{- {Q}_{i} + π {V}_{1} ( \frac{{R}_{i}^{2} - {r}_{1}^{2}}{2 ln ( {r}_{1} / {R}_{i} )} + {r}_{1}^{2} )}{\frac{π}{8 {μ}_{1}} ( {r}_{1}^{2} - {R}_{i}^{2} ) ( {r}_{1}^{2} + {R}_{i}^{2} + \frac{{R}_{i}^{2} - {r}_{1}^{2}}{ln ( {r}_{1} / {R}_{i} )} )} ) \times {L}_{i} \\ [ Mathematical Formula 2 ]$$

$$B = {\sum }_{j = 1}^{n} - ( \frac{{Q}_{gas} + π {V}_{1} ( \frac{{RR}_{j}^{2} - {r}_{1}^{2}}{2 ln ( {r}_{1} / {RR}_{j} )} + {r}_{1}^{2} )}{\frac{π}{8 {μ}_{2}} ( {r}_{1}^{2} - {RR}_{j}^{2} ) ( {r}_{1}^{2} + {RR}_{j}^{2} + \frac{{RR}_{j}^{2} - {r}_{1}^{2}}{ln ( {r}_{1} / {RR}_{j} )} )} ) \times {LL}_{j} \\ [ Mathematical Formula 3 ]$$

$$C = D 1 + D 2 \times {Q}_{gas} + D 3 \times {Q}_{gas}^{2} + D 4 \times V 1 + D 5 \times {Q}_{gas} \times V 1$$

According to the exemplary embodiment of the invention, it is possible to provide the optical fiber cooling apparatus capable of minimizing leakage of a coolant gas from the lower side of the apparatus, and the optical fiber manufacturing method using the cooling apparatus.

### BRIEF DESCRIPTION OF THE DRAWINGS

FIG. 1 is a diagram showing a schematic configuration example of a manufacturing apparatus including an optical fiber cooling apparatus to which the invention is applied.

FIG. 2 is a drawing showing a concrete configuration example of a cooling tube part, a straight tube part and a pressurizing chamber.

FIG. 3 is a diagram describing a mechanism for generating a pressure loss C in the pressurizing chamber.

FIGS. 4A to 4D are diagrams showing one example of coolant gas speed distribution by the optical fiber cooling apparatus of the invention.

FIG. 5 is a diagram (table) summarizing one example of a flow rate reduction effect of the coolant gas from results of FIGS. 4A to 4D.

FIGS. 6A and 6B are diagrams showing one example of a relation between a gas flow rate Q_{gas} of a pressurized gas passed through the straight tube part and the sum ΣLLj of lengths LLj (j=1 to n) of each of the divided units of the straight tube part at the time when a lower gauge pressure A becomes the maximum value, and a relation between a gas flow rate Q_{gas} of the pressurized gas passed through the straight tube part and the sum ΣLLj of lengths LLj (j=1 to n) of each of the divided units of the straight tube part at the time of the lower gauge pressure A=667 (Pa).

FIG. 7 is a diagram showing a related art described in Patent Reference 1.

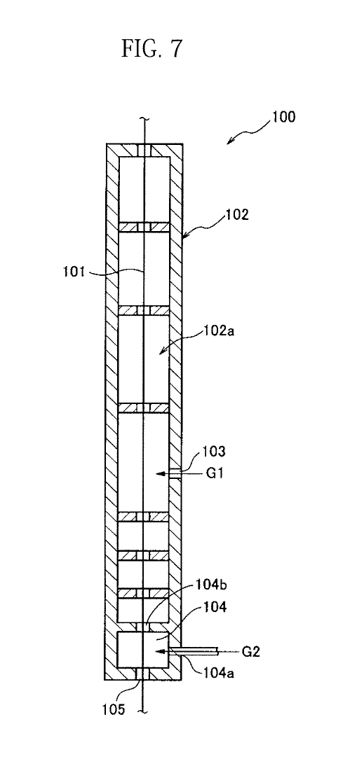

### DETAILED DESCRIPTION

### Description of Embodiment of the Invention

First, the contents of an embodiment of the invention will be listed and described.

(1) An exemplary embodiment of the present invention is an optical fiber cooling apparatus for forcedly cooling an optical fiber drawn from an optical fiber glass preform by a coolant gas, comprising:

a cooling tube part in which a path of the coolant gas is formed;

a pressurizing chamber formed in a lower portion of the cooling tube part; and

a straight tube part formed in a lower portion of the pressurizing chamber,

wherein when a lower gauge pressure of the cooling tube part is set at A, and the number of divided units of the cooling tube part is set at N, and a length of each of the divided units of the cooling tube part is set at Li (i=1 to N), and a radius of each of the divided units of the cooling tube part is set at Ri (i=1 to N), and a gas flow rate of a coolant gas passed through each of the divided units of the cooling tube part is set at Qi (i=1 to N), and a viscosity coefficient of the coolant gas is set at μ1, and a radius of the optical fiber is set at r1, and a drawing speed of the optical fiber is set at V1, and a pressure loss of the straight tube part is set at B, and the number of divided units of the straight tube part is set at n, and a length of each of the divided units of the straight tube part is set at LLj (j=1 to n), and a radius of each of the divided units of the straight tube part is set at RRj (j=1 to n), and a gas flow rate of a pressurized gas passed through the straight tube part is set at Q_{gas}, and a viscosity coefficient of the pressurized gas is set at μ2, and a pressure loss of the pressurizing chamber is set at C, and internal pressure correlation constants of the pressurizing chamber are set at D1 to D5, and a shape correction coefficient of the pressurizing chamber is set at k (1≦k≦2), the following formula is satisfied.

A−B−kC≦0

where

$$[ Mathematical Formula 1 ]$$

$$A = {\sum }_{i = 1}^{N} ( \frac{- {Q}_{i} + π {V}_{1} ( \frac{{R}_{i}^{2} - {r}_{1}^{2}}{2 ln ( {r}_{1} / {R}_{i} )} + {r}_{1}^{2} )}{\frac{π}{8 {μ}_{1}} ( {r}_{1}^{2} - {R}_{i}^{2} ) ( {r}_{1}^{2} + {R}_{i}^{2} + \frac{{R}_{i}^{2} - {r}_{1}^{2}}{ln ( {r}_{1} / {R}_{i} )} )} ) \times {L}_{i} \\ [ Mathematical Formula 2 ]$$

$$B = {\sum }_{j = 1}^{n} - ( \frac{{Q}_{gas} + π {V}_{1} ( \frac{{RR}_{j}^{2} - {r}_{1}^{2}}{2 ln ( {r}_{1} / {RR}_{j} )} + {r}_{1}^{2} )}{\frac{π}{8 {μ}_{2}} ( {r}_{1}^{2} - {RR}_{j}^{2} ) ( {r}_{1}^{2} + {RR}_{j}^{2} + \frac{{RR}_{j}^{2} - {r}_{1}^{2}}{ln ( {r}_{1} / {RR}_{j} )} )} ) \times {LL}_{j} \\ [ Mathematical Formula 3 ]$$

$$C = D 1 + D 2 \times {Q}_{gas} + D 3 \times {Q}_{gas}^{2} + D 4 \times V 1 + D 5 \times {Q}_{gas} \times V 1$$

By determining parameters so that the above formula is satisfied, it is possible to minimize leakage of a coolant gas from the lower side of the apparatus.

(2) It is preferable that a sum of lengths LLj of each of the divided units of the straight tube part is values from 0.001 to 0.5 m (both inclusive).

Accordingly, the straight tube part can be set in a proper length to improve storage capability.

(3) An exemplary embodiment of the present invention is an optical fiber manufacturing method using an optical fiber cooling apparatus for forcedly cooling an optical fiber drawn from an optical fiber glass preform by a coolant gas, the optical fiber cooling apparatus having a cooling tube part in which a path of the coolant gas is formed, a pressurizing chamber formed in a lower portion of the cooling tube part, and a straight tube part formed in a lower portion of the pressurizing chamber,

wherein when a lower gauge pressure of the cooling tube part is set at A, and the number of divided units of the cooling tube part is set at N, and a length of each of the divided units of the cooling tube part is set at Li (i=1 to N), and a radius of each of the divided units of the cooling tube part is set at Ri (i=1 to N), and a gas flow rate of a coolant gas passed through each of the divided units of the cooling tube part is set at Qi (i=1 to N), and a viscosity coefficient of the coolant gas is set at μ1, and a radius of the optical fiber is set at r1, and a drawing speed of the optical fiber is set at V1, and a pressure loss of the straight tube part is set at B, and the number of divided units of the straight tube part is set at n, and a length of each of the divided units of the straight tube part is set at LLj (j=1 to n), and a radius of each of the divided units of the straight tube part is set at RRj (j=1 to n), and a gas flow rate of a pressurized gas passed through the straight tube part is set at Q_{gas}, and a viscosity coefficient of the pressurized gas is set at μ2, and a pressure loss of the pressurizing chamber is set at C, and internal pressure correlation constants of the pressurizing chamber are set at D1 to D5, and a shape correction coefficient of the pressurizing chamber is set at k (1≦k≦2), the following formula is satisfied.

A−B−kC≦0

where

$$[ Mathematical Formula 1 ]$$

$$A = {\sum }_{i = 1}^{N} ( \frac{- {Q}_{i} + π {V}_{1} ( \frac{{R}_{i}^{2} - {r}_{1}^{2}}{2 ln ( {r}_{1} / {R}_{i} )} + {r}_{1}^{2} )}{\frac{π}{8 {μ}_{1}} ( {r}_{1}^{2} - {R}_{i}^{2} ) ( {r}_{1}^{2} + {R}_{i}^{2} + \frac{{R}_{i}^{2} - {r}_{1}^{2}}{ln ( {r}_{1} / {R}_{i} )} )} ) \times {L}_{i} \\ [ Mathematical Formula 2 ]$$

$$B = {\sum }_{j = 1}^{n} - ( \frac{{Q}_{gas} + π {V}_{1} ( \frac{{RR}_{j}^{2} - {r}_{1}^{2}}{2 ln ( {r}_{1} / {RR}_{j} )} + {r}_{1}^{2} )}{\frac{π}{8 {μ}_{2}} ( {r}_{1}^{2} - {RR}_{j}^{2} ) ( {r}_{1}^{2} + {RR}_{j}^{2} + \frac{{RR}_{j}^{2} - {r}_{1}^{2}}{ln ( {r}_{1} / {RR}_{j} )} )} ) \times {LL}_{j} \\ [ Mathematical Formula 3 ]$$

$$C = D 1 + D 2 \times {Q}_{gas} + D 3 \times {Q}_{gas}^{2} + D 4 \times V 1 + D 5 \times {Q}_{gas} \times V 1$$

As well as the above (1), by determining parameters so that the above formula is satisfied, it is possible to minimize leakage of a coolant gas from the lower side of the apparatus.

(4) It is preferable that the pressurized gas includes any of gases of air, nitrogen, argon and carbon dioxide.

Accordingly, relatively inexpensive gases other than the helium gas can be used as the pressurized gas.

(5) It is preferable that a gas flow rate Q_{gas} of the pressurized gas is 0.0015 m³/s or less.

Accordingly, leakage of the coolant gas can be prevented without passing a large amount of pressurized gas.

### Details of Embodiment of the Invention

A concrete example of an optical fiber cooling apparatus and an optical fiber manufacturing method using the cooling apparatus according to an embodiment of the invention will hereinafter be described with reference to the drawings. In addition, the invention is not limited to these illustrations, and is indicated by the claims and is intended to include all changes within the scope and meaning of equivalents and the claims.

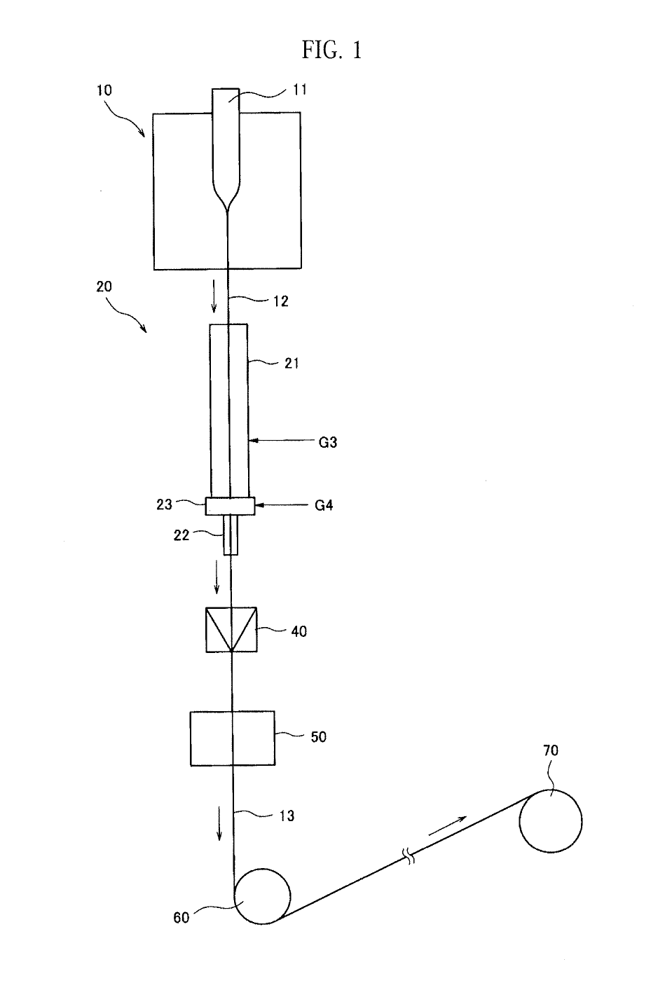

FIG. 1 is a diagram showing a schematic configuration example of a manufacturing apparatus including an optical fiber cooling apparatus to which the invention is applied. In FIG. 1, numeral 10 shows an optical fiber drawing furnace (hereinafter simply called a drawing furnace), and numeral 11 shows an optical fiber glass preform (hereinafter simply called a glass preform), and numeral 12 shows an optical fiber just after drawing, and numeral 13 shows an optical fiber after applying a resin, and numeral 20 shows an optical fiber cooling apparatus (hereinafter simply called a cooling apparatus), and numeral 40 shows a resin applicator, and numeral 50 shows a resin curing device, and numeral 60 shows a guide roller, and numeral 70 shows a rewinding device.

The glass preform 11 is heated and melted by the drawing furnace 10, and the optical fiber 12 is drawn from the downward side of the drawing furnace 10. After the optical fiber 12 drawn from the glass preform 11 is forcedly cooled by the cooling apparatus 20, an ultraviolet curable resin is applied by the resin applicator 40 and this resin is cured by the resin curing device 50. Subsequently, the optical fiber 13 after applying the resin is rewound by the rewinding device 70 through the guide roller 60.

A principal object of the invention is to be able to minimize leakage of a coolant gas from the lower side of the cooling apparatus. As a configuration for this object, the cooling apparatus 20 has a cooling tube part 21 in which a path of a coolant gas is formed, a pressurizing chamber 23 formed in the lower portion of the cooling tube part 21, and a straight tube part 22 formed in the lower portion of the pressurizing chamber 23 as shown in FIG. 1.

When a lower gauge pressure (that is, a differential pressure from atmospheric pressure) of the cooling tube part 21 is set at A, and the number of divided units of the cooling tube part 21 is set at N, and a length of each of the divided units of the cooling tube part 21 is set at Li (1=1 to N), and a radius of each of the divided units of the cooling tube part 21 is set at Ri (i=1 to N), and a gas flow rate of a coolant gas G3 passed through each of the divided units of the cooling tube part 21 is set at Qi (1=1 to N), and a viscosity coefficient of the coolant gas G3 is set at μ1, and a radius of the optical fiber 12 is set at r1, and a drawing speed (drawing speed) of the optical fiber 12 is set at V1, and a pressure loss of the straight tube part 22 is set at B, and the number of divided units of the straight tube part 22 is set at n, and a length of each of the divided units of the straight tube part 22 is set at LLj (j=1 to n), and a radius of each of the divided units of the straight tube part 22 is set at RRj (j=1 to n), and a gas flow rate of a pressurized gas G4 passed through the straight tube part 22 is set at Q_{gas}, and a viscosity coefficient of the pressurized gas G4 is set at μ2, and a pressure loss of the pressurizing chamber 23 is set at C, and internal pressure correlation constants of the pressurizing chamber 23 are set at D1 to D5, and a shape correction coefficient of the pressurizing chamber 23 is set at k (1≦k≦2), it is configured to satisfy the following Formula 1.

A−B−kC≦0 Formula 1

Where

$$[ Mathematical Formula 1 ]$$

$$A = {\sum }_{i = 1}^{N} ( \frac{- {Q}_{i} + π {V}_{1} ( \frac{{R}_{i}^{2} - {r}_{1}^{2}}{2 ln ( {r}_{1} / {R}_{i} )} + {r}_{1}^{2} )}{\frac{π}{8 {μ}_{1}} ( {r}_{1}^{2} - {R}_{i}^{2} ) ( {r}_{1}^{2} + {R}_{i}^{2} + \frac{{R}_{i}^{2} - {r}_{1}^{2}}{ln ( {r}_{1} / {R}_{i} )} )} ) \times {L}_{i} \\ [ Mathematical Formula 2 ]$$

$$B = {\sum }_{j = 1}^{n} - ( \frac{{Q}_{gas} + π {V}_{1} ( \frac{{RR}_{j}^{2} - {r}_{1}^{2}}{2 ln ( {r}_{1} / {RR}_{j} )} + {r}_{1}^{2} )}{\frac{π}{8 {μ}_{2}} ( {r}_{1}^{2} - {RR}_{j}^{2} ) ( {r}_{1}^{2} + {RR}_{j}^{2} + \frac{{RR}_{j}^{2} - {r}_{1}^{2}}{ln ( {r}_{1} / {RR}_{j} )} )} ) \times {LL}_{j} \\ [ Mathematical Formula 3 ]$$

$$C = D 1 + D 2 \times {Q}_{gas} + D 3 \times {Q}_{gas}^{2} + D 4 \times V 1 + D 5 \times {Q}_{gas} \times V 1$$

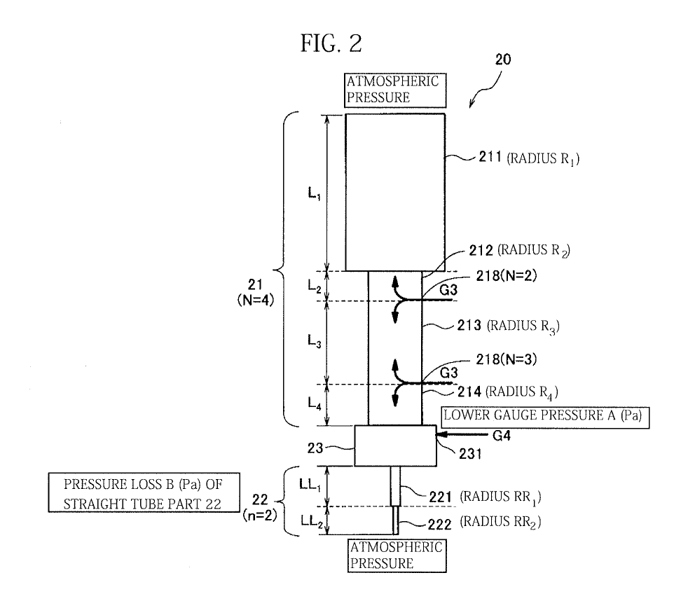

A concrete configuration example of the cooling tube part 21, the straight tube part 22 and the pressurizing chamber 23 will hereinafter be described based on FIG. 2. The example of FIG. 2 shows the case where the number N of divided units of the cooling tube part 21 is set at “N=4” and the number n of divided units of the straight tube part 22 is set at “n=2”.

That is, the cooling tube part 21 is divided into four (N=4) units, and has a first divided unit 211 with a length L₁ and a radius R₁, a second divided unit 212 with a length L₂ and a radius R₂, a third divided unit 213 with a length L₃ and a radius R₃, and a fourth divided unit 214 with a length L₄ and a radius R₄. Also, the cooling tube part 21 has two coolant gas inflow ports 218 (N=2, 3) for making the coolant gas G3 flow into.

In the above, the lengths L₁ to L₄ of the divided units of the cooling tube part 21 are defined by a distance between radius change regions, a distance between the coolant gas inflow ports 218 or the minimum distance of the distance between radius change regions and the distance between the coolant gas inflow ports 218 as shown in FIG. 2. Also, in the case of the present example, the coolant gas G3 flows into the cooling tube part 21 from the two coolant gas inflow ports 218, and the number of coolant gas inflow ports 218 can be set at one or more.

Here, the lower gauge pressure A (Pa) is a lower side pressure of the cooling tube part 21 in the case of being assumed that the coolant gas G3 flows from the one or more coolant gas inflow ports 218, and a flow direction of the coolant gas G3 may be any of upward and downward directions. In addition, in the gas flow rate Qi (i=1 to N) of the coolant gas G3, the upward direction is set at a positive and the downward direction is set at a negative.

For each of the parameters of the cooling tube part 21, the radius Ri (i=1 to N) of each of the divided units 211 to 214 of the cooling tube part 21 is desirably values from 1.5 to 5 mm (both inclusive) from the standpoint of cooling capability or contact with the optical fiber 12. In addition, each of the divided units 211 to 214 may have the same or different radius Ri.

Also, when the length of each of the divided units 211 to 214 constructing the cooling tube part 21 is set at Li (1=1 to N), the sum of the lengths Li of each of the divided units 211 to 214 is desirably 15 m or less from the standpoint of the restrictions of equipment. Each of the divided units 211 to 214 may also have the same or different length Li.

Also, the coolant gas G3 passed through the cooling tube part 21 is, for example, a helium gas, and the viscosity coefficient μ1 is a viscosity coefficient at the time when a gas temperature is values from 230 to 400 K (both inclusive), and becomes μ1=1.9×10⁻⁵ to 2.4×10⁻⁵ (Pa·s) for the helium gas. Also, the gas flow rate Qi (i=1 to N) of the helium gas passed through each of the divided units 211 to 214 is desirably values from −3.33×10⁻⁴ m³/s (=−20 L/min) to 3.33×10⁻⁴ m³/s (=20 L/min) (both inclusive). In addition, as described above, the upward direction is set at a positive and the downward direction is set at a negative.

Next, the straight tube part 22 is divided into two (n=2) units, and has a first divided unit 221 with a length LL₁ and a radius RR₁, and a second divided unit 222 with a length LL₂ and a radius RR₂. The lengths LL₁ and LL₂ of the divided units of the straight tube part 22 are defined as a distance between radius change regions as shown in FIG. 2.

Here, the pressure loss B (Pa) is a pressure loss in the straight tube part 22 in the case of being assumed that all the pressurized gas G4 flowing from the pressurizing chamber 23 flows downwardly. The pressurized gas G4 passed through the straight tube part 22 could be a gas other than the helium gas, and relatively inexpensive gases including, for example, air, nitrogen, argon or carbon dioxide can be used preferably. The viscosity coefficient μ2 of the pressurized gas G4 is a viscosity coefficient at the time when a gas temperature is values from 230 to 400 K (both inclusive), and becomes μ2=1.7×10⁻⁵ to 2.3×10⁻⁵ (Pa·s) for the air.

Also, the gas flow rate Q_{gas} of the pressurized gas G4 is desirably 0.0015 m³/s (=90 L/min) or less. Accordingly, leakage of the coolant gas G3 can be prevented without passing a large amount of pressurized gas G4. In addition, in the case of passing the pressurized gas G4 more than 0.0015 m³/s, vibration etc. of the optical fiber may occur. Also, the radius RRj (j=1 to n) of each of the divided units 221, 222 of the straight tube part 22 is desirably values from 0.5 to 4.0 mm (both inclusive). In addition, each of the divided units 221, 222 may have the same or different radius RRj. Accordingly, contact with the optical fiber 12 can be prevented and also, the flow rate of the pressurized gas G4 can be decreased. Also, the sum of the lengths LLj (j=1 to n) of each of the divided units 221, 222 of the straight tube part 22 is desirably values from 0.001 to 0.5 m (both inclusive). Each of the divided units 221, 222 may also have the same or different length LLj. Accordingly, the straight tube part 22 can be set in a proper length to improve storage capability.

Next, the pressurizing chamber 23 will be described. The pressurizing chamber 23 is provided with a pressurized gas inflow port 231 for making the pressurized gas G4 flow into. Here, the pressure loss C (Pa) of the pressurizing chamber 23 can be obtained from a simulation result of fluid analysis software, and a coefficient is obtained by solving simultaneous equations calculated as a function of the gas flow rate Q_{gas} and the drawing speed V1 assuming that the pressure loss C depends on the gas flow rate Q_{gas} of the pressurized gas G4 and the drawing speed V1 of the optical fiber 12. Also, it is apparent that the pressure loss C has a difference according to a shape of the pressurizing chamber 23. As a result, Formula 1 can be corrected by assigning the shape correction coefficient k taking on values from 1 to 2 (both inclusive) according to the shape of the pressurizing chamber 23. In addition, the internal pressure correlation constants D1 to D5 of Mathematical Formula 3 are constant values, and can be illustrated with, for example, D1≈−73.30 (Pa), D2≈−17.61 (kg/m⁴s), (kg/m⁷), D4≈3.16 (kg/m²s) and D5≈1.64 (kg/m⁵), and these values are obtained by changing conditions (the gas flow rate Q_{gas} and the drawing speed V1) for a simulation result of fluid analysis software and doing a five-point calculation and solving simultaneous equations as described above.

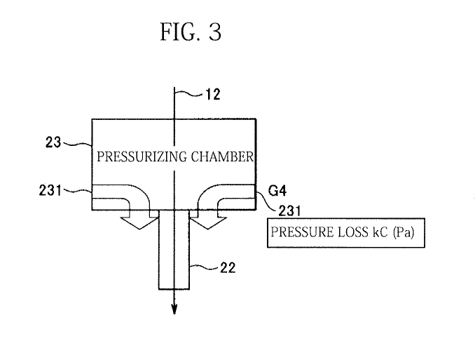

FIG. 3 is a diagram describing a mechanism for generating the pressure loss C in the pressurizing chamber 23. Since the optical fiber 12 travels downwardly at a high speed, the pressurized gas G4 is suddenly accelerated by a pulling effect of the optical fiber 12 and the pressure loss C is generated. In FIG. 3, the pressurized gas G4 flows into the pressurizing chamber 23 from the pressurized gas inflow port 231, and since the optical fiber 12 is pulled at the drawing speed V1 at this time, the inflow pressurized gas G4 is suddenly accelerated and the pressure loss C is generated inside the pressurizing chamber 23.

In addition, the pressure loss C is multiplied by the shape correction coefficient k and the correction is made as described above. This shape correction coefficient k takes on the values from 1 to 2 (both inclusive) according to the shape of the pressurizing chamber 23 and, for example, the shape correction coefficient k becomes “1” for a relatively large pressurizing chamber, and the shape correction coefficient k becomes “2” for a relatively small pressurizing chamber.

In this manner, each of the parameters of Formula 1 is determined so that the lower gauge pressure A of the cooling tube part 21 is less than or equal to the sum of the pressure loss B of the straight tube part 22 and the pressure loss kC multiplied by the shape correction coefficient k in the pressurizing chamber 23. That is, leakage of the coolant gas from the lower side of the cooling tube part 21 is minimized by increasing the pressure loss B of the straight tube part 22 and the pressure loss kC of the pressurizing chamber 23. In other words, the coolant gas which is fluid has high fluid resistance, and does not flow to the straight tube part 22 with a large pressure loss, and flows as an upward flow to the cooling tube part 21 with a small pressure loss, with the result that the leakage of the coolant gas from the lower side of the cooling tube part 21 can be reduced.

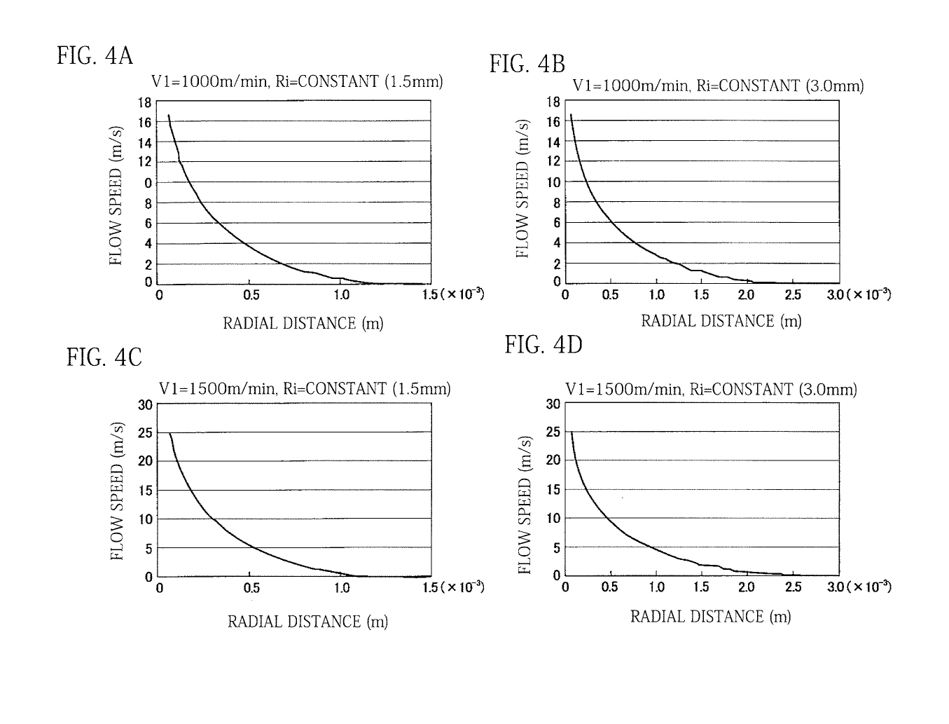

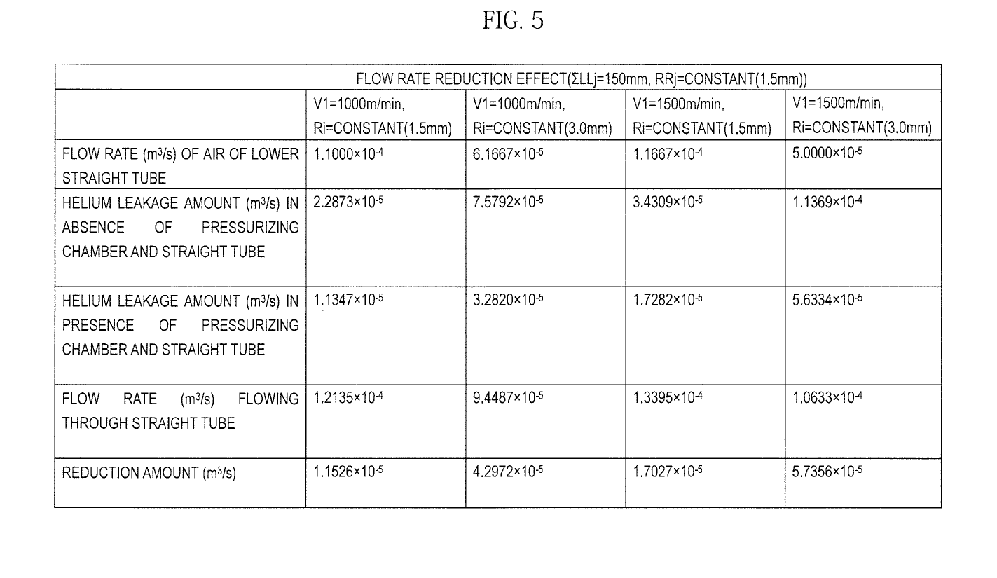

FIGS. 4A to 4D are diagrams showing one example of coolant gas speed distribution by the optical fiber cooling apparatus of the invention, and is the diagram describing a reverse flow limit flow rate (a flow rate at which the coolant gas and the pressurized gas do not flow upwardly). FIG. 5 is a diagram (table) summarizing one example of a flow rate reduction effect of the coolant gas from results of FIGS. 4A to 4D. In the case of the present example, the number N of divided units of the cooling tube part 21 is set at “N=1” (one-step configuration), and the number n of divided units of the straight tube part 22 is set at “n=1” (one-step configuration). And, the length LL₁ of the straight tube part 22 was set at 150 mm, and the radius RR₁ of the straight tube part 22 was set at 1.5 mm. Also, the length L₁ of the cooling tube part 21 was set at 5.0 m, and the radius R₁ of the cooling tube part 21 was set at 1.5 mm or 3.0 mm. Also, the drawing speed V1 of the optical fiber 12 was set at 1000 m/min or 1500 m/min.

In addition, the coolant gas G3 is set at a helium gas, and the pressurized gas G4 is set at air, and the radius r1 of the optical fiber 12 is set at 62.5 μm, and the viscosity coefficient μ1 is set at 2.0×10⁻⁵ (Pa·s), and the viscosity coefficient μ2 is set at 1.81×10⁻⁵ (Pa·s). Also, the gas flow rate Q_{gas} of the pressurized gas G4 corresponds to a “flow rate of air of the lower straight tube” of FIG. 5, and is obtained as a limit value in which a reverse flow does not occur on each condition. Graphs of FIGS. 4A to 4D calculate a relation between a radial distance (m) of the cooling tube part 21 and a flow speed (m/s) of the coolant gas G3 so as to satisfy the condition of Formula 1 described above, that is, A−B−kC=0 based on each of these parameters. In addition, the flow speed (m/s) of the coolant gas G3 can be obtained by dividing the gas flow rate Gi (m³/s) by a cross-sectional area (m²) of the cooling tube part 21.

FIG. 4A shows an example in which the drawing speed V1 is 1000 m/min and the radius Ri of the cooling tube part 21 is 1.5 mm, and FIG. 4B shows an example in which the drawing speed V1 is 1000 m/min and the radius Ri of the cooling tube part 21 is 3.0 mm, and FIG. 4C shows an example in which the drawing speed V1 is 1500 m/min and the radius Ri of the cooling tube part 21 is 1.5 mm, and FIG. 4D shows an example in which the drawing speed V1 is 1500 m/min and the radius Ri of the cooling tube part 21 is 3.0 mm. In FIGS. 4A to 4D, the axis of abscissa shows a radial distance (m) of the cooling tube part 21 and the axis of ordinate shows a flow speed (m/s). In other words, the graphs of FIGS. 4A to 4D show the downward flow speed distribution in the radial direction of the lower end of the cooling tube part 21.

It is apparent from FIGS. 4A to 4D that the flow speed of the helium gas becomes high in the vicinity of the outer periphery of the optical fiber 12 and the flow speed of the helium gas becomes gradually lower in a direction away from the optical fiber 12 since the optical fiber 12 travels in the center (the vicinity of the radius 0) of the cooling tube part 21. FIGS. 4A to 4D show the flow speed distribution of the limit in which a reverse flow does not occur (the flow speed does not fall below 0) since the helium gas catches the pressurized gas in the cooling tube and flows reversely (flows upwardly) when the flow speed falls below 0 herein.

Here, an integral value in the radial direction in FIGS. 4A to 4D is a “helium leakage amount in the presence of the pressurizing chamber and the straight tube” in FIG. 5. Also, a “flow rate flowing through the straight tube” in FIG. 5 is the sum of the “helium leakage amount in the presence of the pressurizing chamber and the straight tube” and a “flow rate of air of the lower straight tube”. Also, a “helium leakage amount in the absence of the pressurizing chamber and the straight tube” is a helium leakage amount in a configuration of the absence of the pressurizing chamber and the straight tube as shown in a related example, and can be obtained from an integral value in the radial direction like the above by calculating a relation between a radial distance (m) of the cooling tube part 21 and a flow speed (m/s) of the coolant gas G3 so as to satisfy the lower gauge pressure A=0 in consideration of only the lower gauge pressure A in Formula 1 described above.

A difference between this “helium leakage amount in the absence of the pressurizing chamber and the straight tube” and the “helium leakage amount in the presence of the pressurizing chamber and the straight tube” is a “reduction amount”, and becomes a helium flow rate capable of reduction by having a configuration of the optical fiber cooling apparatus of the embodiment.

Next, the maximum value and the minimum value of the lower gauge pressure A (Pa) are obtained when the radius Ri (i=1 to N) of the cooling tube part 21 is set at values from 1.5 to 5 mm (both inclusive) and the sum of the lengths Li (i=1 to N) is set at 15 m or less and the coolant gas G3 passed through the cooling tube part 21 is set at a helium gas and the gas flow rate Qi (i=1 to N) of the helium gas is set at values from −3.33×10⁻⁴ m³/s (=−20 L/min) to 3.33×10⁻⁴ m³/s (=20 L/min) (both inclusive) in consideration of a reverse flow.

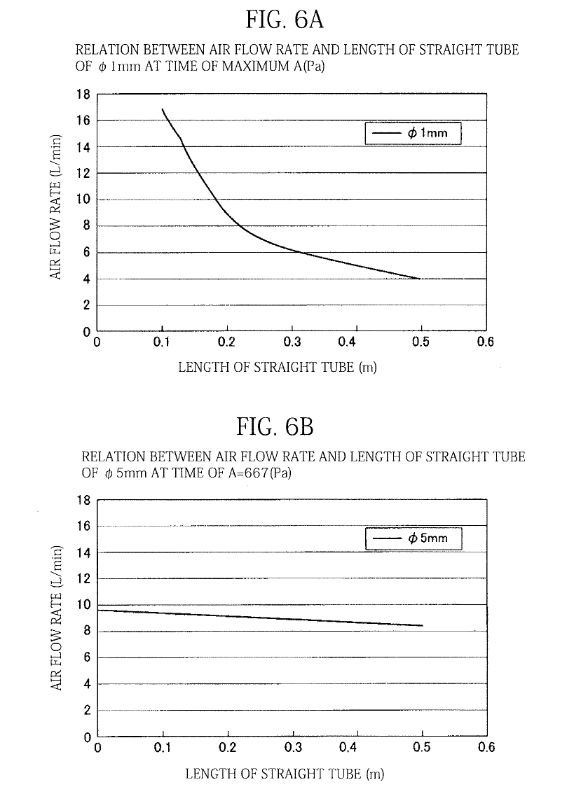

When the maximum value and the minimum value of the lower gauge pressure A are obtained based on each of the parameters and Formula 1 described above, the maximum pressure becomes 39828 (Pa) and the minimum pressure becomes 255 (Pa) on this condition. FIG. 6A shows a result of obtaining a relation between the gas flow rate Q_{gas} of the pressurized gas passed through the straight tube part 22 and the sum ΣLLj of the lengths LLj (j=1 to n) of each of the divided units of the straight tube part 22 so as to satisfy Formula 1 when the lower gauge pressure A becomes the maximum pressure (=39828 Pa). In addition, FIG. 6A is a result of setting an inside diameter of the straight tube part 22 at φ1 mm.

In FIG. 6A, the axis of abscissa shows the sum ΣLLj (m) of the lengths of the straight tube part 22 and the axis of ordinate shows the gas flow rate Q_{gas} (L/min) of the pressurized gas passed through the straight tube part 22. As described above, the sum ΣLLj of the lengths of the straight tube part 22 is desirably set at values from 0.001 to 0.5 m (both inclusive) from the standpoint of storage capability. It is apparent from FIG. 6A that the gas flow rate Q_{gas} can be decreased as ΣLLj is longer, and the gas flow rate becomes substantially constant in the straight tube length of about 0.5 m.

In addition, FIG. 6A is the calculated result of the case where the lower gauge pressure A becomes the maximum pressure, but there is a possibility that the lower gauge pressure A does not become high to the maximum pressure actually. FIG. 6B shows a result of obtaining a relation between the gas flow rate Q_{gas} of the pressurized gas passed through the straight tube part 22 and the sum ΣLLj of the lengths LLj (j=1 to n) of each of the divided units of the straight tube part 22 so as to satisfy Formula 1 when the number N of divided units of the cooling tube part 21 is set at “N=1” (one-step configuration) and the number n of divided units of the straight tube part 22 is set at “n=1” (one-step configuration) like FIGS. 4A to 4D and the length L₁ of the cooling tube part 21 is set at 5.0 m and the radius R₁ of the cooling tube part 21 is set at 1.5 mm and the drawing speed V1 of the optical fiber is set at 1500 m/min and the lower gauge pressure A is set at 667 (Pa). In addition, FIG. 6B is a result of setting an inside diameter of the straight tube part 22 at φ5 mm. It is apparent from FIG. 6B that the gas flow rate Q_{gas} can be decreased as ΣLLj is longer like FIG. 6A but a larger inside diameter of the straight tube part 22 has a less influence of the length.

What is claimed is:

1. An optical fiber cooling apparatus for forcedly cooling an optical fiber drawn from an optical fiber glass preform by a coolant gas, comprising:
a cooling tube part in which a path of the coolant gas is formed;
a pressurizing chamber formed in a lower portion of the cooling tube part; and
a straight tube part formed in a lower portion of the pressurizing chamber,
wherein when a lower gauge pressure of the cooling tube part is set at A, and the number of divided units of the cooling tube part is set at N, and a length of each of the divided units of the cooling tube part is set at Li (i=1 to N), and a radius of each of the divided units of the cooling tube part is set at Ri (i=1 to N), and a gas flow rate of a coolant gas passed through each of the divided units of the cooling tube part is set at Qi (i=1 to N), and a viscosity coefficient of the coolant gas is set at μ1, and a radius of the optical fiber is set at r1, and a drawing speed of the optical fiber is set at V1, and a pressure loss of the straight tube part is set at B, and the number of divided units of the straight tube part is set at n, and a length of each of the divided units of the straight tube part is set at LLj (j=1 to n), and a radius of each of the divided units of the straight tube part is set at RRj (j=1 to n), and a gas flow rate of a pressurized gas passed through the straight tube part is set at Q_{gas}, and a viscosity coefficient of the pressurized gas is set at μ2, and a pressure loss of the pressurizing chamber is set at C, and internal pressure correlation constants of the pressurizing chamber are set at D1 to D5, and a shape correction coefficient of the pressurizing chamber is set at k the following formula is satisfied.
A−B−kC≦0
where
$$[ Mathematical Formula 1 ]$$
$$A = {\sum }_{i = 1}^{N} ( \frac{- {Q}_{i} + π {V}_{1} ( \frac{{R}_{i}^{2} - {r}_{1}^{2}}{2 ln ( {r}_{1} / {R}_{i} )} + {r}_{1}^{2} )}{\frac{π}{8 {μ}_{1}} ( {r}_{1}^{2} - {R}_{i}^{2} ) ( {r}_{1}^{2} + {R}_{i}^{2} + \frac{{R}_{i}^{2} - {r}_{1}^{2}}{ln ( {r}_{1} / {R}_{i} )} )} ) \times {L}_{i} \\ [ Mathematical Formula 2 ]$$
$$B = {\sum }_{j = 1}^{n} - ( \frac{{Q}_{gas} + π {V}_{1} ( \frac{{RR}_{j}^{2} - {r}_{1}^{2}}{2 ln ( {r}_{1} / {RR}_{j} )} + {r}_{1}^{2} )}{\frac{π}{8 {μ}_{2}} ( {r}_{1}^{2} - {RR}_{j}^{2} ) ( {r}_{1}^{2} + {RR}_{j}^{2} + \frac{{RR}_{j}^{2} - {r}_{1}^{2}}{ln ( {r}_{1} / {RR}_{j} )} )} ) \times {LL}_{j} \\ [ Mathematical Formula 3 ]$$
$$C = D 1 + D 2 \times {Q}_{gas} + D 3 \times {Q}_{gas}^{2} + D 4 \times V 1 + D 5 \times {Q}_{gas} \times V 1$$

2. The optical fiber cooling apparatus as claimed in claim 1, wherein a sum of lengths LLj of each of the divided units of the straight tube part is values from 0.001 to 0.5 m (both inclusive).

3. An optical fiber manufacturing method using an optical fiber cooling apparatus for forcedly cooling an optical fiber drawn from an optical fiber glass preform by a coolant gas, the optical fiber cooling apparatus having a cooling tube part in which a path of the coolant gas is formed, a pressurizing chamber formed in a lower portion of the cooling tube part, and a straight tube part formed in a lower portion of the pressurizing chamber,
wherein when a lower gauge pressure of the cooling tube part is set at A, and the number of divided units of the cooling tube part is set at N, and a length of each of the divided units of the cooling tube part is set at Li (i=1 to N), and a radius of each of the divided units of the cooling tube part is set at Ri (i=1 to N), and a gas flow rate of a coolant gas passed through each of the divided units of the cooling tube part is set at Qi (i=1 to N), and a viscosity coefficient of the coolant gas is set at μ1, and a radius of the optical fiber is set at r1, and a drawing speed of the optical fiber is set at V1, and a pressure loss of the straight tube part is set at B, and the number of divided units of the straight tube part is set at n, and a length of each of the divided units of the straight tube part is set at LLj (j=1 to n), and a radius of each of the divided units of the straight tube part is set at RRj (j=1 to n), and a gas flow rate of a pressurized gas passed through the straight tube part is set at Q_{gas}, and a viscosity coefficient of the pressurized gas is set at μ2, and a pressure loss of the pressurizing chamber is set at C, and internal pressure correlation constants of the pressurizing chamber are set at D1 to D5, and a shape correction coefficient of the pressurizing chamber is set at k (1≦k2), the following formula is satisfied.
A−B−kC≦0
where
$$[ Mathematical Formula 1 ]$$
$$A = {\sum }_{i = 1}^{N} ( \frac{- {Q}_{i} + π {V}_{1} ( \frac{{R}_{i}^{2} - {r}_{1}^{2}}{2 ln ( {r}_{1} / {R}_{i} )} + {r}_{1}^{2} )}{\frac{π}{8 {μ}_{1}} ( {r}_{1}^{2} - {R}_{i}^{2} ) ( {r}_{1}^{2} + {R}_{i}^{2} + \frac{{R}_{i}^{2} - {r}_{1}^{2}}{ln ( {r}_{1} / {R}_{i} )} )} ) \times {L}_{i} \\ [ Mathematical Formula 2 ]$$
$$B = {\sum }_{j = 1}^{n} - ( \frac{{Q}_{gas} + π {V}_{1} ( \frac{{RR}_{j}^{2} - {r}_{1}^{2}}{2 ln ( {r}_{1} / {RR}_{j} )} + {r}_{1}^{2} )}{\frac{π}{8 {μ}_{2}} ( {r}_{1}^{2} - {RR}_{j}^{2} ) ( {r}_{1}^{2} + {RR}_{j}^{2} + \frac{{RR}_{j}^{2} - {r}_{1}^{2}}{ln ( {r}_{1} / {RR}_{j} )} )} ) \times {LL}_{j} \\ [ Mathematical Formula 3 ]$$
$$C = D 1 + D 2 \times {Q}_{gas} + D 3 \times {Q}_{gas}^{2} + D 4 \times V 1 + D 5 \times {Q}_{gas} \times V 1$$

4. The optical fiber manufacturing method as claimed in claim 3, wherein the pressurized gas includes any of gases of air, nitrogen, argon and carbon dioxide.

5. The optical fiber manufacturing method as claimed in claim 3, wherein a gas flow rate Q_{gas} of the pressurized gas is 0.0015 m³/s or less.
